(19) United States
(12) Patent Application Publication
(10) Pub. No.: US 2015/0278335 A1
(43) Pub. Date: Oct. 1, 2015

(54) SCALABLE BUSINESS PROCESS INTELLIGENCE AND PREDICTIVE ANALYTICS FOR DISTRIBUTED ARCHITECTURES

(71) Applicant: Kofax, Inc., Irvine, CA (US)

(72) Inventors: Scott Opitz, Media, PA (US); Alex Elkin, Acton, MA (US); Anthony Macciola, Irvine, CA (US)

(21) Appl. No.: 14/675,397

(22) Filed: Mar. 31, 2015

Related U.S. Application Data
(60) Provisional application No. 61/973,006, filed on Mar. 31, 2014.

(51) Int. Cl. G06F 17/30

(52) U.S. Cl. CPC G06F 17/30592; G06F 17/30324

(57) ABSTRACT

Systems, methods, and computer program products for scalable, efficient business intelligence platforms and analytical processes are disclosed. In general, the inventive techniques, systems, and products include receiving data relating to a business or a business process; processing the received data according to a metadata model, wherein the processing comprises generating metadata corresponding to each of a plurality of data portions; partitioning the received data into the plurality of data portions based at least in part on the metadata corresponding to the data portion, and distributing each of the plurality of data portions and the metadata corresponding to each respective data portion across a plurality of resources arranged in a distributed architecture. The metadata model comprises characteristics descriptive of the data, the characteristics include semantic characteristics; extract, transform, load (ETL) characteristics; and usage characteristics.

### RELATED APPLICATIONS

The present application claims priority to U.S. Provisional Patent Application No. 61/973,006, filed Mar. 31, 2014 and entitled “Scalable Business Process Intelligence and Predictive Analytics for Distributed Architectures”, the contents of which are herein incorporated by reference.

### FIELD OF INVENTION

The present invention relates to data management, particularly data management across distributed system architectures. Even more specifically, the present inventive concepts relate to systems, techniques, and/or products configured to manage data across a distributed system architecture. The data are managed for the specific purpose of determining and providing business intelligence and/or predictive analytics relating to business process(es) in connection with/relation to which the data were collected, generated, produced, acquired, etc.

### BACKGROUND

In known business intelligence and analytics, data may be distributed across an architecture using any number of conventional segregation schemes (e.g. designating particular resources for a specific purpose or department, such as an architecture including separate resources for production, quality control, shipping, receiving, accounting, human resources, customer relations, etc.). Each separate component of the architecture may include processing resources and/or storage resources. Exemplary processing resources may include hardware and/or software. In some instances, processing resources include context-specific tools such as analytic software configured to analyze and provide business intelligence relating to business data (which may optionally be stored locally or remotely to the processing resource).

The conventional business intelligence leverages data stored in a “warehouse” convention where data are distributed, if at all, according to conventional approaches such as described above.

Warehoused data are discovered and located using a process whereby a user formulates a standard query (e.g. an SQL query or other query suitable for use in connection with a conventional relational database structure) and submits the query to a controlling entity (e.g. a data storage controller) for processing. The controlling entity exhaustively distributes the query to all resources with which the entity is in communication, and receives replies indicating the result for each resource.

To achieve acceptable performance, conventional business intelligence approaches require loading an entire data set in memory in order to perform any manipulation or calculations using the data contained therein.

While the conventional brute-force approach to data distribution effectively reduces storage load imposed on any particular resource, and similarly reduces job processing time by splitting the Fork load across multiple processors, the unintelligent nature of the storage and processing paradigm introduces significant inefficiencies to the overall system and associated processes.

For example, in order to conduct the typical processing operation using stored data, conventional approaches require storing the entire data set in memory and performing the corresponding processing operations on the fully-loaded data set. Naturally this requirement introduces limits on the maximum size of a data set capable of being processed using any given resource. Since business data integration and analytics rely on increasingly larger and more complex data sets, the conventional approaches therefore present hard limits on achievable performance.

Moreover, conventional data storage follows a paradigm whereby each access point for the data set (e.g. each user having access to or ownership of the data) maintains a set of associations between the access point and data set (usually in the form of data pointers or references). System overhead requirements accordingly increase as a function of the number of users requiring access to the data set. A general rule of thumb is that a system requires approximately 10% additional resource capacity (e.g. memory) per user associated with a data set. Thus, if a system requires 100 GB of memory to process a data set associated with a single user, the same system will require 200 GB of memory to similarly process the same data set if associated with ten users.

Conventional compression techniques, therefore, even if capable of achieving a high degree of footprint reduction (e.g. a particularly successful footprint reduction might achieve as much as a 10:1 compression ratio) are quickly negated by even a modest increase in user access requirements.

Conventional BI leverages conventional query structures and processes to locate and retrieve data stored across the plurality of resources according to the brute three approach. As a result, redundancies and inconsistencies (e.g. version history) may exist with respect to a particular datum as stored in different locations. However, the query will nonetheless report all data fitting the conditions defined therein without respect to such redundancies, inconsistencies, or other problematic issues inherent to the conventional approach.

Worse still, the requirement of holding the entire data set in memory for processing purposes imposes a hard performance limit on the system that does not scale with increasing data requirements or with the system itself. In other words, if a data set having a footprint of about 1 TB has access only to 0.75 TB of memory, the process breaks, or proceeds at a glacial pace not acceptable under real-world constraints.

Many of these analytical platforms have therefore reached the capacity of traditional data management techniques and turned to in-memory solutions to solve performance issues. Using in-memory, in association with business intelligence platforms, facilities lower the latency between when analytical queries are initiated and the results can be used to move an organization forward.

First-generation in-memory BI products are limited to using the memory found on a single server. This problem is aggravated by the fact that they also require as much as an additional 10% data overhead for each user, causing even modest data volumes to quickly max out on most servers.

With the growth in processing power and memory availability, many platforms (server/desktop/laptop) underutilize available computer resources of processor(s) and memory. The in-memory approaches lower the amount of “round-trip” time from data management location to processing execution by moving data from traditional (i.e. “spinning-disk”) data management to main memory space data management. For example, files stored on a disk or a database management system (DBMS) that stores information on disk).

These in-memory implementations are based on several common characteristics of conventional approaches. For example, in-memory implementations are limited to processing within the limits of the memory space available on a single platform (such as a server or a desktop or laptop for single user environments). Additionally, the in-memory facilities are typically apportioned according to a particular (e.g. vendor implementation), rather than being utilized as a general purpose data management resource.

As a result, many of these conventional approaches and environments utilize approximately half of the available memory on a platform's (server/desktop/laptop) memory space. Within this limited memory allocation, a compression factor (depending greatly on the types of data being stored) of approximately 3-5× can be achieved for a single user environment, effectively reducing the data footprint on the overall system. For example, on a standard commodity server with 24 GB of memory serving, most in-memory facilities for business intelligence platforms support processing of datasets having between approximately 36 GB and 60 GB of data.

Using a proprietary in-memory data management solution rather than a general use DBMS, many business intelligence platforms segregate the information in specific data structures and limit access to that information. Since the various segregated components are NOT configured or capable of acting in the capacity of a general use database, the information can only be accessed by a particular vendor's methodology or via a complex data access system.

Accordingly, there are costs associated with the implementation of in-memory in business intelligence platforms. Many of these early stage in-memory facilities are based on a proprietary structure specific to a particular vendor's implementation. This allows for particular workload considerations to be made as to memory management and data compression. These components allow vendors to make the best use of the available memory associated with a platform as well as their knowledge of the information managed by the solution. However, they can be a “black-box” as far as tuning and resource allocation. This lack of visibility into the inner workings can prevent architects and administrators from properly apportioning resources for their particular environment.

Next, the memory space utilized by the in-memory facilities only “scales up” inside of the existing platform (server/desktop/laptop). As the number of users increases, the capacity requirements for the environment also rise. Each additional user requires approximately an additional 10% for overlapping analytical requirements. This comes in the form of overhead for dataset intersection and individual user information. This reduces the amount of available space for core data to be analyzed. A server environment, similar to the one detailed above supporting 10 users instead of must one, would be capable of supporting a reduced set of data due to these constraints. Instead of 36-60 GB of data, only 15-25 GB of information would be served in the same memory space due to the increased user demands.

Finally, as many of these in-memory facilities are NOT general-use databases, it is difficult to share information with other applications. With the exception of NoSQL data management platforms, standard data access methodologies are the pathways to integrate information across data stores. Yet these proprietary structures do not communicate with long standing Structured Query Language (SQL) to provide integration outside of the analytical platform.

The aforementioned standard approaches to implementing early stage in-memory technology, introduce limiting factors.

First, scale, or scalability, is a primary concern. The ability for these platforms to match growing and widespread analytical requirements significantly limits where and how in-memory can be applied without manually driven partitioning techniques.

Second, moving to an all in-memory approach creates compatibility issues because this technique deviates from industry standards common to the current world where “spinning disk” is utilized as an effective option for data management. In-memory is an excellent answer to address the growing requirements for analytics. Yet traditional data management provides a good complement for both operational and economic reasons.

Third, early stage in-memory facilities focus mainly on leveraging technical metadata to drive performance improvement via memory allocation and data compression. This narrow focus fails to realize the entire benefit offered by employing general-purpose metadata models and performance management paradigms.

Mindful of these limitations, it would be useful to provide in-memory facilities for business intelligence platforms improvements to distributed computing, coordination between data management approaches, and utilization of additional layers of metadata to optimize both the performance and economics of analytical environments.

### SUMMARY OF THE INVENTION

The presently disclosed inventive concepts generally relate to scalable business intelligence and analytics, and provide seamless, efficient techniques, systems and computer program products for

[symbol]

In one embodiment, a method, includes: receiving data relating to a business or a business process; processing the received data according to a metadata model, wherein the processing comprises generating metadata corresponding to each of a plurality of data portions; partitioning the received data into the plurality of data portions based at least in part on the metadata corresponding to the data portion, and distributing each of the plurality of data portions and the metadata corresponding to each respective data portion across a plurality of resources arranged in a distributed architecture. The metadata model comprises characteristics descriptive of the data, the characteristics include semantic characteristics; extract, transform, load (ETL) characteristics; and usage characteristics.

In another embodiment a method includes: receiving one or more seed values representing a current state of a business; receiving historical business state data representing a plurality of historical states of the business over a predetermined period of time; using at least one processor, continuously simulating one or more business processes utilizing the one or more seed values and a model based on the historical business state data; and detecting a deviation from an expected progression in the simulation.

In yet another embodiment, a computer program product includes a computer readable storage medium having embodied therewith computer readable program instructions configured to cause at least one processor, upon execution, to: receive data relating to a business or a business process; process the received data according to a metadata model, wherein the processing comprises generating metadata corresponding to each of a plurality of data portions; partition the received data into the plurality of data portions based at least in part on the metadata corresponding to the data portion, and distribute each of the plurality of data portions and the metadata corresponding to each respective data portion across a plurality of resources arranged in the distributed architecture; wherein the metadata model comprises characteristics descriptive of the data, the characteristics comprising: semantic characteristics; extract, transform, load (ETL) characteristics; and usage characteristics.

Of course, the foregoing are simply illustrative embodiments and the various inventive features will be appreciated more fully as set forth in the detailed descriptions and figures.

### BRIEF DESCRIPTION OF THE DRAWINGS

FIG. 1 depicts an architecture, according to one embodiment.

FIG. 2 shows a representative hardware environment associated with a user device and/or server, in accordance with one embodiment.

FIG. 3 depicts a distributed architecture operating generally according to the principles of one embodiment of the invention.

FIG. 4 is a flowchart of a method, according to one embodiment.

FIG. 5 is a flowchart of a method, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The present application refers to data management. More specifically, the presently disclosed inventive concepts apply to data management and disclose superior techniques, system architectures, program products, etc. that enable sharing of data across a plurality of systems.

As referred to herein, a system, technique, product, etc. is considered “highly-scalable” wherever users, administrators, machines (physical and/or virtual), access points, etc. may be added to and/or removed from an existing architecture without introducing additional overhead to the management and/or operation thereof.

In one general embodiment, a method, includes: receiving data relating to a business or a business process; processing the received data according to a metadata model, wherein the processing comprises generating metadata corresponding to each of a plurality of data portions; partitioning the received data into the plurality of data portions based at least in part on the metadata corresponding to the data portion, and distributing each of the plurality of data portions and the metadata corresponding to each respective data portion across a plurality of resources arranged in a distributed architecture. The metadata model comprises characteristics descriptive of the data, the characteristics include semantic characteristics; extract, transform, load (ETL) characteristics; and usage characteristics.

In another general embodiment a method includes: receiving one or more seed values representing a current state of a business; receiving historical business state data representing a plurality of historical states of the business over a predetermined period of time; using at least one processor, continuously simulating one or more business processes utilizing the one or more seed values and a model based on the historical business state data; and detecting a deviation from an expected progression in the simulation.

In yet another general embodiment, a computer program product includes a computer readable storage medium having embodied therewith computer readable program instructions configured to cause at least one processor, upon execution, to: receive data relating to a business or a business process; process the received data according to a metadata model, wherein the processing comprises generating metadata corresponding to each of a plurality of data portions; partition the received data into the plurality of data portions based at least in part on the metadata corresponding to the data portion, and distribute each of the plurality of data portions and the metadata corresponding to each respective data portion across a plurality of resources arranged in the distributed architecture; wherein the metadata model comprises characteristics descriptive of the data, the characteristics comprising: semantic characteristics; extract, transform, load (ETL) characteristics; and usage characteristics.

### General Networking and Computing Concepts

As understood herein, a mobile device is any device capable of receiving data without having power supplied via a physical connection (e.g. wire, cord, cable, etc.) and capable of receiving data without a physical data connection (e.g. wire, cord, cable, etc.). Mobile devices within the scope of the present disclosures include exemplary devices such as a mobile telephone, smartphone, tablet, personal digital assistant, iPod®, iPad®, BLACKBERRY® device, etc.

Of course, the various embodiments set forth herein may be implemented utilizing hardware, software, or any desired combination thereof. For that matter, any type of logic may be utilized which is capable of implementing the various functionality set forth herein.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), afield programmable gate array (FPGA), etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

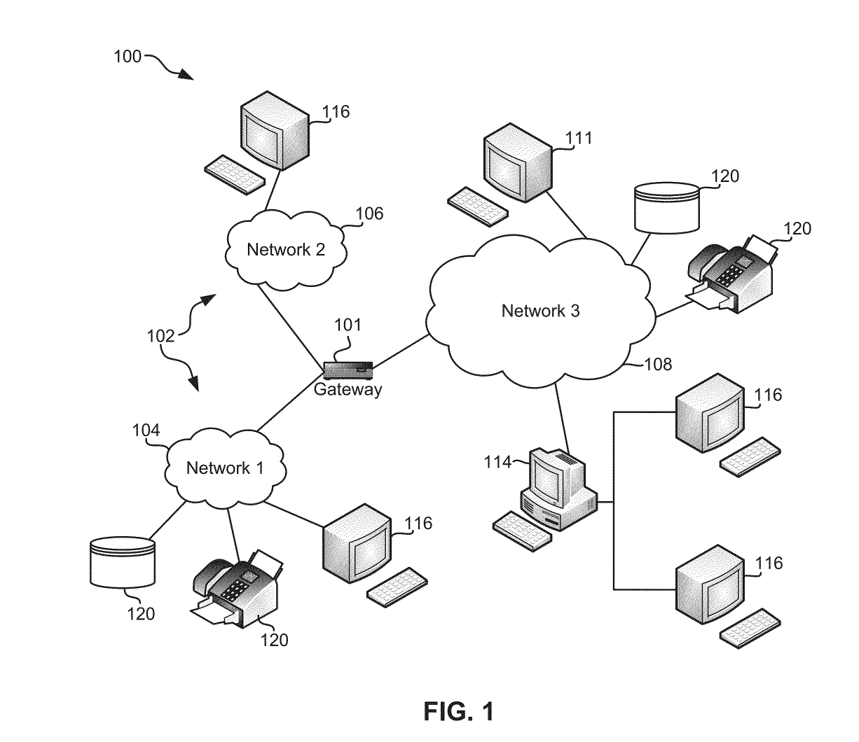

FIG. 1 illustrates an architecture 100, in accordance with one embodiment. As shown FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function a which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

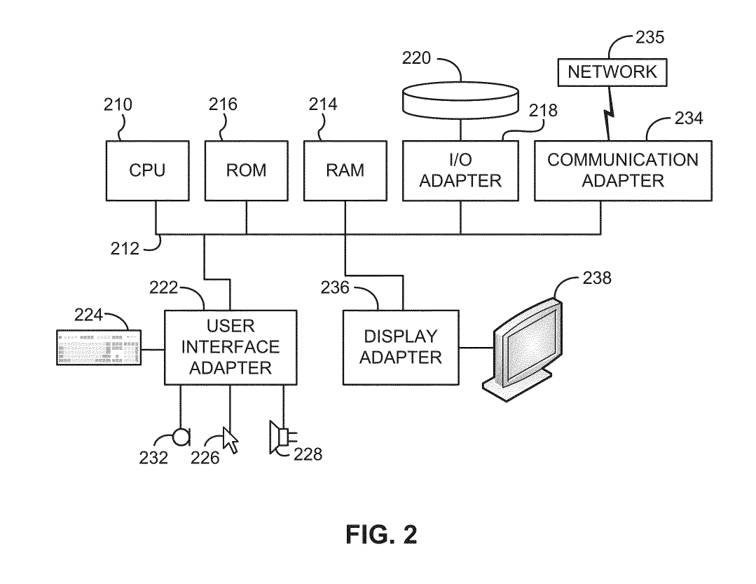

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

An application may be installed on the mobile device, e.g., stored in a nonvolatile memory of the device. In one approach, the application includes instructions to perform processing of an image on the mobile device. In another approach, the application includes instructions to send the image to a remote server such as a network server. In yet another approach, the application may include instructions to decide whether to perform some or all processing on the mobile device and/or send the image to the remote site.

In various embodiments, the presently disclosed methods, systems and/or computer program products may utilize and/or include any of the functionalities disclosed in related U.S. patent application Ser. No. 11/163,867, filed Nov. 2, 2005 and entitled “SYSTEM AND METHOD FOR DISCOVERY OF BUSINESS PROCESSES”; U.S. patent application Ser. No. 11/164,619, filed Nov. 30, 2005 and entitled “STATE ENGINE FOR BUSINESS PROCESS EXECUTION”; as well as U.S. patent application Ser. No. 11/309,286, filed Jul. 21, 2006 and entitled “METHOD AND SYSTEM FOR IMPROVING THE ACCURACY OF A BUSINESS FORECAST”.

As discussed below, a “datum” or “data” should be understood to include any representation of information in digital (e.g. binary) format. Similarly, a “dataset” may be understood to include a collection of data arranged in any known or suitable format, such as any of the conventionally known data structures in modern computing including an array, hash, table, graph, network, relational database, etc. as would be understood by one having ordinary skill in the art.

Similarly, within the context of business processes or business intelligence, “data” should be understood to refer to any measurable or quantifiable expression of information, typically in numerical units (such as a date, amount, etc.) or an alphanumeric string indicating membership in a particular class (e.g. a “label” such as a unit of measure, including United States Dollars ($), Euros ( [symbol] ), inches (in.), centimeters (cm), hours (hr), kilograms (kg), megabytes (MB), a qualitative category such as color, gender, legal status, etc. as would be understood by one having ordinary skill in the art upon reading the present descriptions).

Common examples of business intelligence “data” include any expression of resources received and/or expended (e.g. expenses incurred, revenue received, inventory in stock, etc.), measure of progress (e.g. time past, proximity to predefined goal, accumulation of an absolute amount, etc.) or any other useful information in the context of analyzing business processes as would be understood by skilled artisans reviewing the instant disclosures.

Similarly, as referred to herein “metrics” should be understood to include any value, conclusion, result, product, etc. that is achieved by combining or evaluating two or more pieces of data. For example, continuing with the exemplary data set forth above, an illustrative metric that may be calculated from data including EXPENSES and REVENUE would be PROFIT MARGIN that could be calculated in a simple scenario by subtracting EXPENSES from REVENUE to determine a corresponding PROFIT MARGIN. Of course, other data of any type may be combined in any suitable manner that would be appreciated by a person having ordinary skill in the art as beneficial or informative to a business process upon reading these descriptions.

The change to the common elements of early stage in-memory facilities for business intelligence platforms is to utilize the developments in distributed processing. Many existing business intelligence platforms will take advantage of distributed processing with the platform's (server/desktop/laptop) CPU. Advancements multi-core processors have advanced this practice. However, in terms of being able to distribute data across multiple memory spaces, many business intelligence platforms focus on a single platform approach, which limits the amount of addressable memory space, or is constrained to the amount of memory a platform is capable of supporting. This is attribute of a system is referred to as “scalability” or the ability to “scale up” into a single memory space.

Branching out across multiple platforms to take advantage of not only parallel processing across multiple CPU cores, but across multiple memory spaces, provides a great opportunity to match expanding data requirements. This concept is called “scaling out” across multiple memory spaces. Platforms that are capable of scaling out can effectively expand to meet just about any data requirement by adding additional hardware. Bringing together multiple commodity hardware components for coordinated and parallel uses is a more effective solution than a single large server environment.

Technology acquisition costs are also beneficially reduced. Architecture and implementation flexibility is increased. Moreover, and most importantly, the amount of addressable memory space grows. Above an example was used to display how additional users lowered the amount of available memory on a single environment. “Scale out” allows for the same amount of data to be used while increasing users. This type of environment also supports the stated growing data requirements.

Complementing the capacity to span multiple platforms (server/desktop/laptop) is the ability to coordinate with “spinning disk” DBMS facilities to use the right data management tool for the job. Using both in-memory and traditional options allows for greater flexibility in configuration and architecture. This allows for data requiring near-real-time operational access to be positioned within an in-memory facility. Data with lower response requirements can be located within a “spinning-disk” environment.

This situation also allows for risk mitigation associated with data growth. In either a single platform “scale up” situation or a multi-server “scale out” environment, memory space is an inevitable limitation. In this situation, there is a risk that a business intelligence platform will run into one of two situations. The platform will fail due to the lack of available space. The other option is that the operating system will take over memory management via “virtual memory” or begin swapping information between main memory and “spinning-disk.”

Since the operating system is performing this task for general purposes, the analytical application performance will suffer. In this situation, an administrator has limited options to mitigate the risk of failure or reduced performance. By utilizing a traditional database as a complementary component, the power of the “spinning disk” DBMS can be used to maintain a particular level of performance.

Finally, business intelligence platforms are only beginning to utilize the power of the metadata associated with the information that they manage. Technical metadata has long been part of the management of information associated with analytics. With the increasing levels of semantic metadata available to business intelligence platforms, the value of using a wider range of metadata increases. Similar datasets and common domain metrics can be collocated within the data management environment, whether it is in-memory or “spinning-disk”. Collocating and coordinating data delivers additional value associated with processing of analytics. Customer information can be collocated together. In addition, detail data regarding Revenue can be positioned with aggregate, or roll-up, metrics associated with fine-grain information.

### MAPAGGREGATE® Solution

With the driver of improved analytical response, business intelligence platforms are quickly moving toward implementing in-memory technologies. Many of these implementations share limiting factors such as requiring predefined data structures and organizational schemes, lack of ability to “scale out” to multiple memory space and a lack of coordinated metadata facilities. Bridging across these boundaries is key to overcoming limitations of the conventional approach, which enable distributed system architectures and techniques to transition from a patchwork of context-specific “one off” solutions to a ubiquitous, efficient and long-lasting general-purpose solution for performance-based data management.

One approach is the so-called “MAPAGGREGATE®” data management functionality, which allows for several solutions to conventional in-memory technology described above. For ease of comprehension, the “MAPAGGREGATE®” approaches disclosed herein may be comparatively viewed with reference to conventional “Map-Reduce” approaches as known in the art (see, e.g.: “Map-Reduce”, Wikipedia, http://en.wikipedia.org/wiki/MapReduce (last accessed Feb. 21, 2014)).

MAPAGGREGATE® preferably uses a distributed server based approach. This is different from other desktop or single server implementations. By using “scale out” functionality, MAPAGGREGATE® enables organizations to expand across multiple memory spaces as opposed to relying on a single memory space. Single memory spaces, as mentioned above, have the limitation of running out of available memory and/or being dependent on the operating system for the management of virtual memory. Both of these issues can prevent organizations from meeting the level of performance required by their business stakeholders.

The presently disclosed techniques, including MAPAGGREGATE®, enable users, architects and administrators to plan for and meet the requirements of their business stakeholders with multiple commodity hardware-based solutions. By being able to implement additional commodity hardware as necessary, the administrators can economically and dynamically expand to meet growing data requirements.

Accompanying “scale out” capabilities for in-memory performance is an inventive approach conferring ability to manage data requirements across multiple data management options. Simply put, not all data requires the speed and performance of in-memory processing and storage facilities. Matching in-memory performance with the balancing attributes of traditional “spinning-disk” capabilities means that the right tool can be used for the right job. The presently discussed paradigm provides in-memory facilities that span into a traditional data management environment. This can meet several challenges in one platform. MAPAGGREGATE® allows users to utilize additional processing power and data storage of a “spinning-disk” DBMS without process and query failure.

The instant techniques also facilitate administrators design capabilities with respect to both the operational environments and assess the requirements of their unique business situations. Decisions can be made as to how data is allocated across both in-memory and “spinning disk” options. Administrators can balance those requirements in association with their existing environment and long-term data center and budget resources. MAPAGGREGATE®, as disclosed presently, provides the capability to design and configure a platform to meet not just data sizing with increased servers for “scale out”, but budget and operational considerations.

Yet another attribute that allows a business intelligence platform to make the most of both in-memory and “spinning disk” data management is a comprehensive metadata management facility. This goes beyond just the ability to determine the technical metadata of the analytics. It extends to the semantic attributes of metadata and the usage information of the metrics and queries. The ability to identify and manage all of these attributes, again, puts the power of design and architecture in the hands of a platform administrator rather than the operating system or a black-box configuration.

This level of metadata insight is provided via a tool referred to herein as “metrics mart.” Metrics Mart provides visibility on which information should reside in in-memory and which data elements that are best served by “spinning-disk” data management. Decisions are not based on technical aspects alone. Architects can make designs to position business information in common memory spaces to facilitate aggregation for particular analytical workloads.

In essence, the Metrics Mart is a single enterprise library that maintains a verified state of the data, metadata, and metrics. This enables codeless analytics and improved data access across the various resources of the distributed architecture, and is particularly powerful in combination with MAPAGGREGATE® because MAPAGGREGATE® enables the exploitation of memory and processing resources across the distributed architecture.

All of the elements that empower a business intelligence platform to best use in-memory facilities and are associated with avoiding the “one size fits” all approach that many business intelligence vendors are taking with their implementation of in-memory. Scale-out, mixed use between data management facilities and advanced use of available metadata provide for the opportunity to avoid the barriers. The MAPAGGREGATE® approach to in-memory for business intelligence and analytics meets these particular requirements and positions organizations to avoid the pitfalls associated with early stage in-memory implementations.

In general, MAPAGGREGATE® combines in-memory data management approaches with distributed system architectures and relational database concepts to provide a comprehensive data storage and processing solution via a cohesive engine. The engine runs on three enabling precepts: (1) a single metadata model shared among all points in the distributed architecture and for all data to be managed by the engine or across the architecture; (2) a (preferably relational) database management system (DBMS) configured to organize pre-processed data (e.g. according to metadata falling within the single metadata model described above and alternatively referred to as a “Metrics Mart”); and (3) a distributed architecture across which to employ the single metadata model and management system.

More specifically, the single metadata model may be understood in terms of three primary aspects. In one aspect, the model is a semantic model—a description of metrics and records (facts) in terms of definition, time breakdowns, available dimensions, nature of these dimensions (dictionary, unique values), user access restrictions, interdependencies, etc. as would be understood by one having ordinary skill in the art upon reading the present descriptions. In a second aspect, the model is an extract, transform, load (ETL) model. In other words, the metadata may serve s the source of metrics and records, refresh frequency and volumes, overwriting logic, etc. as would be understood by one having ordinary skill in the art upon reading the present descriptions. In a third aspect, the model is a usage model—with metadata describing where and how these metrics and records are used in dashboards and report.

As referred to below, pre-processing data may include preprocessing the data according to one or more of the aforementioned aspects to generate, manipulate, associate, etc. metadata in connection h the preprocessed data according to the single metadata model.

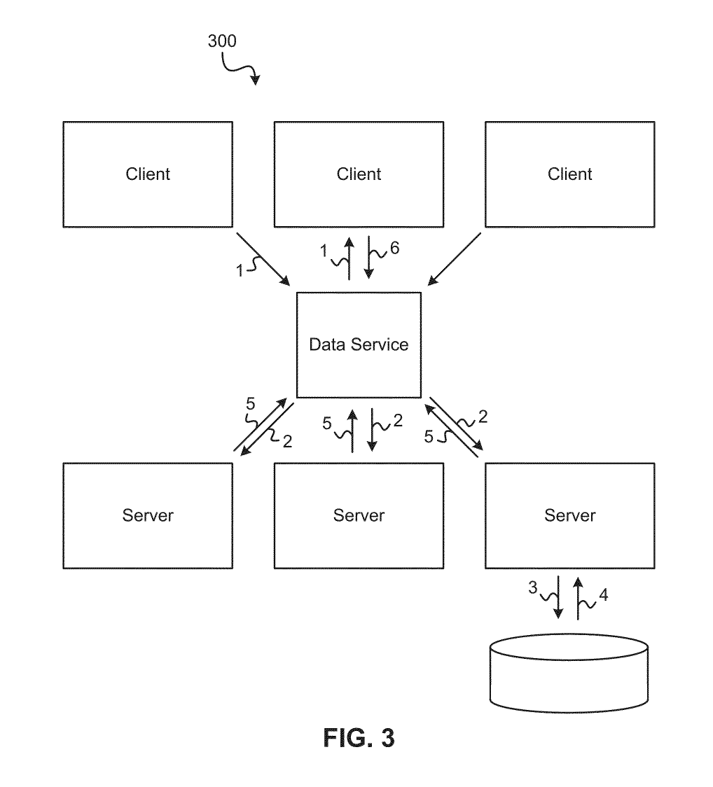

For example, with reference to an exemplary architecture 300 as depicted in FIG. 3, the presently disclosed inventive concepts will be schematically presented, according to one illustrative embodiment.

In general, MAPAGGREGATE® functions according to a three-step process. First, data are partitioned across the distributed architecture 300. Second, data requests are received by a data service. Third, responses to the requests are generated and processed. Further detail regarding each step is provided below.

Regarding data partitioning and distribution, in general data are pre-processed via the data management system (preferably the DBMS, e.g. “metrics mart” described above) and the results are partitioned across all available server resources. The partitioning is performed according to a model derived from some combination of factors including metadata-based heuristics and predefined storage conventions, practices, etc. optionally defined by an administrator. Within the memory of a single server, data are placed based on the metadata defined according to the preprocessing described above. For example, data may be placed on metadata sematic characteristics, ETL characteristics, usage characteristics, etc.

Regarding receipt of data requests after the data are partitioned, in general MAPAGGREGATE® operates by facilitating communications between data consumers (e.g. dashboards, report engines, alert engines, etc.) based on the same overarching single metadata model being employed across the broad expanse of the distributed architecture.

For example, and with reference to FIG. 3 above, in one embodiment a client request or requests 1 are received by a data service. The request 1 may optionally be generated by the client or by another component within the distributed architecture or in communication with the distributed architecture.

Advantageously, the request(s) 1 are received in a format corresponding to (i.e. comprehensible by or within) the single metadata model. In one illustrative scenario, a request following e single metadata model may be expressed in a format substantially representing “calculate datapoints: REVENUE, EXPENSES, and PROFIT MARGIN for a duration covering the previous 12 MONTHS and sort those results according to criteria: DEPARTMENT and COUNTRY.” Since the requests are expressed in the single metadata model terms, they are capable of being efficiently processed by a MAPAGGREGATE® engine (e.g., within the data service), and the processed requests are mapped 2 into the respective servers, e.g. servers hosting the appropriate REVENUE, EXPENSE and PROFIT MARGIN data in one embodiment.

In one embodiment generally following the preceding example, the metric “PROFIT MARGIN” was specifically introduced because it is not hosted anywhere but rather calculated on the fly from the Revenue and Expense which are actually hosted.

Subsequent to pre-processing, the mapped requests 2 are distributed into respective servers based on the received client request 1 using the single metadata model. Subsequently, each server processes the mapped request 2 received thereby. Upon receipt, the server processes the mapped request 2 to determine if the corresponding requested data already is loaded into (or otherwise resides in) memory. If so, the data may be aggregated in memory. Alternatively, if the data reside only partially in memory, and partially elsewhere (e.g. in the DBMS) or entirely elsewhere, then the server generates and executes appropriate queries 3 (e.g. to the DBMS) to locate the requested data.

Upon locating the requested data, any necessary processing, e.g. aggregating, filtering, formatting, etc. of data stored separately on a single server may optionally be performed by the server, and the resulting (aggregated or original) single “chunk” of located data 4 may be returned to the data service in a response 5.

The data service receives response(s) 5 and aggregates portions of the data relating to the initial request 1 and performs any necessary processing, calculation, evaluation, manipulation, formatting, etc. of the data to perform the operations necessary to accede to the initial (client) request 1.

For example, according to the illustrative scenario set forth above, EXPENSES and REVENUE are data stored on various servers, and PROFIT MARGIN is a metric that may be calculated using those data. Upon receiving the aggregated EXPENSE and REVENUE data from the respective servers in the form of response(s) 5, the data service may utilize those aggregate data to calculate corresponding PROFIT MARGIN for the corresponding duration.

Upon calculating and/or aggregating the requisite metric(s) from the data, the final results are assembled and returned in a context-appropriate response 6 to the client submitting the initial request 1. The process may be repealed and/or any number of times according to any number of criteria limited only by the imagination of the user and the depth and breadth of attributes represented in the data partitioned across the distributed architecture.

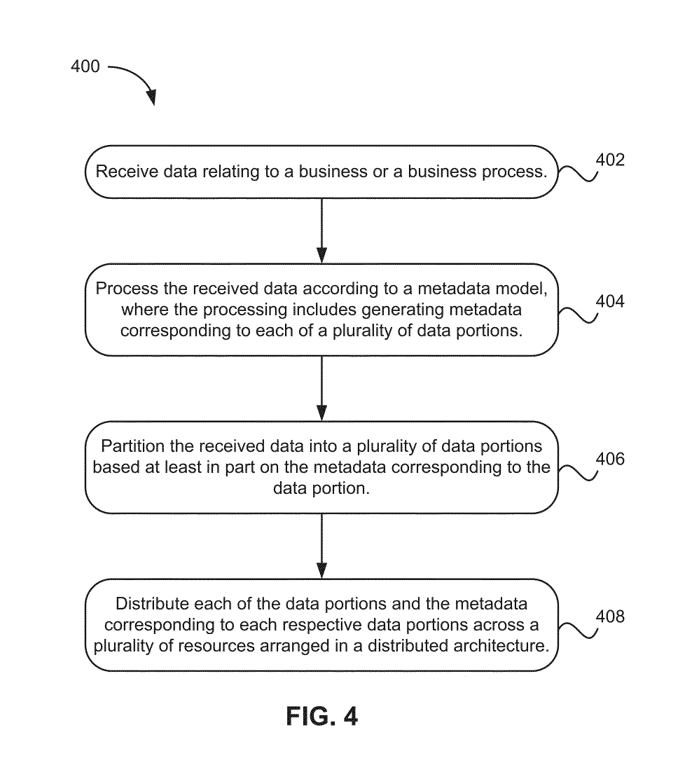

Now with reference to FIG. 4, an exemplary embodiment of a method 400 for managing data across a distributed architecture is shown. The method 400 may be viewed as one illustrative approach to a MAPAGGREGATE® solution for data management. The method 400 may be performed in any suitable environment, including those depicted in FIGS. 1-3, or any other suitable environment that would be appreciated by a person having ordinary skill in the art upon reading the present descriptions.

As shown, method 400 includes operation 402, in which data relating to a business or business process are received.

In operation 404, the received data are processed according to a metadata model. The metadata model includes characteristics that described the data, such as semantic characteristics, ETL characteristics, and usage characteristics. The processing includes generating metadata corresponding to each of a plurality of portions of the data (data portions).

In operation 406, received data are partitioned into the plurality of data portions based at least in part on analyzing the metadata corresponding to each respective data portion.

In operation 408, each of the data portions are distributed, along with the corresponding metadata, across a plurality of resources arranged in a distributed architecture.

Of course, in various approaches it may be advantageous to include one or more additional and/or alternative features in any combination, permutation, synthesis, and/or modification thereof that would be appreciated by a skilled artisan reading the present disclosures. For example, in several illustrative embodiments the presently disclosed method 400 may include any one or more of the following features or operations.

In particularly preferred approaches, the method also includes receiving a request relating to some or all of the data; mapping the request to one or more of the plurality of resources in the distributed architecture based on metadata in the request; receiving one or more responses from each of the plurality of resources in response to mapping the request; processing the one or more responses to generate a report; and returning the report to a resource from which the request was received.

The request may include the metadata corresponding to the data. For example, a request for PROFIT MARGIN includes REVENUE and EXPENSE metadata.

In order to facilitate seamless and efficient distribution and analysis of data, the mapping preferably directs the request to at least one resource where a data service relating to the request resides.

The method may also include determining a location of the requested data prior to the aggregating the one or more responses. The location determined is either “in-memory” or “archived,” where “in-memory” indicates a resource currently loaded for active use by the distributed architecture, such as a processor performing a processing task, a storage device mounted for I/O, a DBMS loaded for storage or management of data, etc. On the other hand, the data location “archived” corresponds to either a resource (such as storage device) of the distributed architecture that is not currently “in-memory” or a storage location in a database management system (DBMS) that is not currently “in-memory.”

Where the location of the requested data is determined to be “in-memory.” the processing is preferentially performed directly in response to this determination in order to efficiently and seamlessly enable distribution and processing of data throughout the distributed architecture.

The method may also include: generating one or more requests in response to determining the location of at least some of the requested data is “archived;” and executing the queries to retrieve the requested data from the “archived” location.

The method may also include: loading the data retrieved from the “archived” location into a memory; and determining the location of the requested data is “in-memory” in response to the loading. Preferably, the aggregating is performed directly in response to determining the location of the requested data is “in-memory”.

The method may include calculating one or more metrics based on the data.

The report is preferably based at least in part on one or more of the data, the metrics, and the request. For example, the report may include a contextual analysis of the data in view of the provided metrics and/or the request itself. The method may also include calculating one or more metrics based on the data, in which case the report is based at least in part on one or more of the data, the metrics, and the request.

Preferably, each data portion is characterized by at least one characteristic unique from all other data portions in the received data, and each data portion is associated with at least one metadata label.

### Continuous Simulation

In another aspect, the presently disclosed techniques may leverage powerful predictive analytics capability that further extends process intelligence. The new capability, called continuous simulation, provides a mechanism for improved operational forecasting based on business processes being monitored by the presently described systems and techniques. These forecasts are continually updated and refined based on the actual operational data being collected, resulting in higher accuracy.

Continuous simulation overcomes the limitations of traditional statistical and static process model-based forecasting approaches. Traditional statistical techniques, while adequate for forecasting steady-state trends, cannot detect and predict the impact of sudden changes to historical patterns. Static process models also often result in poor results, due to issues with the model quality, as well as incorrect assumptions related to the conditions being simulated. Continuous simulation eliminates these issues by using a dynamic process model that is confirmed by operational systems and continually adjusts based on the latest conditions.

In one approach, continuous simulation includes the following general features. First, a current state of a business is determined, received, defined, etc. In essence the state of the business may take any form known in the art, and may be represented using any suitable data, model, etc. In a preferred approach, a current state of the business is obtained via business intelligence, e.g. as one or more seed values suitable for use as an initial state for a process simulation. The state of the business may be obtained via a user, via a predetermined or predefined “default” state, as output from a business process or group of business processes, or according to any other suitable manner or combination of techniques as would be understood by one having ordinary skill in the art upon reading the present descriptions.

Preferably, the state of the business is determined according to a manner, technique, etc. that includes commensurate historical business state data, e.g. a recordation of the state of the business as observed, defined, measured, calculated, etc. over an extended duration, such as several business days, weeks, months, “quarters” (e.g. an approximately three-month duration), years, fiscal periods, investment cycles, etc. as would be understood by a skilled artisan reading these descriptions. The state of the business is accordingly collected, observed, or otherwise obtained over an extended duration of time, and optionally compiled into a repository of “historical” business state data.

The historical data may be organized, subdivided, etc. according to any known or useful convention, e.g. the historical business state data may be organized chronologically by month or fiscal period, and further organized according to geographic location (e.g. business territory, legal jurisdiction, country, etc.). Of course the historical data may be organized according to any number of criteria, structures, etc. as would be understood by one having ordinary skill in the art reading the instant disclosures.

Utilizing the business state data, in some approaches the presently disclosed techniques may perform continuous simulation, e.g. utilizing a model (such as a predefined business and/or statistical model, a model based on historical business state data, a standard model, etc. as would be appreciated by a person having ordinary skill in the art upon reading the present disclosures).

In even more preferred approaches, continuous simulation utilizes the historical business state data and the current business state data to perform continuous simulation of business process(es) and detect deviation(s) from an expected or desired simulation progression (e.g. detect deviation from a business model according to one or more data points, metrics, analyses, etc., such as a deviation in expected PROFIT MARGIN as discussed above in one exemplary scenario) using the historical business state data in the course of a business process simulation. Based on the simulation, one or more possible real-world business scenarios may be simulated and the impact of various potential responses (including taking no action at all, e.g. no response) may be experimentally tested, observed, and evaluated to assist a decision-making entity with understanding and directing the course of a business in various hypothetical scenarios as modeled by the continuous simulation.

Deviations from expected or desired simulation progression may be detected and/or measured according to any suitable technique. For example, in one approach a deviation may be embodied in a threshold, and detected upon the threshold being met or exceeded, such as a particular value measured in the course of determining a state of a business (e.g. revenue) deviating by a predetermined or dynamically-determined amount based on the historical business state information. In the exemplary approach involving revenue as a type of business state information, a deviation from historical business state data may be detected in the course of a simulation whenever the corresponding simulated business revenue diverges from the historical data by a magnitude of about 10% or greater, in one approach.

For example, the revenue may either fall to 90% or less of historical revenue (i.e. the revenue is 10% or more lower than the historically-observed revenue) or increase to 110% of historical revenue (i.e. the revenue is 10% higher than historically-observed revenue) and the simulation may take one or more actions in response to detecting this deviation. In one embodiment, the simulation may generate a log comprising the business state information and information regarding any business process actively influencing said business state information (e.g. sales activity, purchase or requisitions activity, investment activity, regulatory activity such as taxes, fines, etc.) in a manner sufficient to allow a skilled artisan to review the business state information and determine therefrom one or more contributing factors or causative processes leading up to the observed deviation.

Of course, the simulation may involve no human intervention, in some embodiments, and may include a plurality of predefined criteria or thresholds by which a simulation progress may be measured. The automated system may be configured to take predetermined action in response to detecting the presence of one or more of the predefined criteria or thresholds being satisfied, passed, etc. In this manner, various business process development strategies may be tested empirically based on historical business information and intelligent choices may be enacted based on the success or failure of a given strategy in a particular context (i.e. under specific facts as reflected by historical business state information).

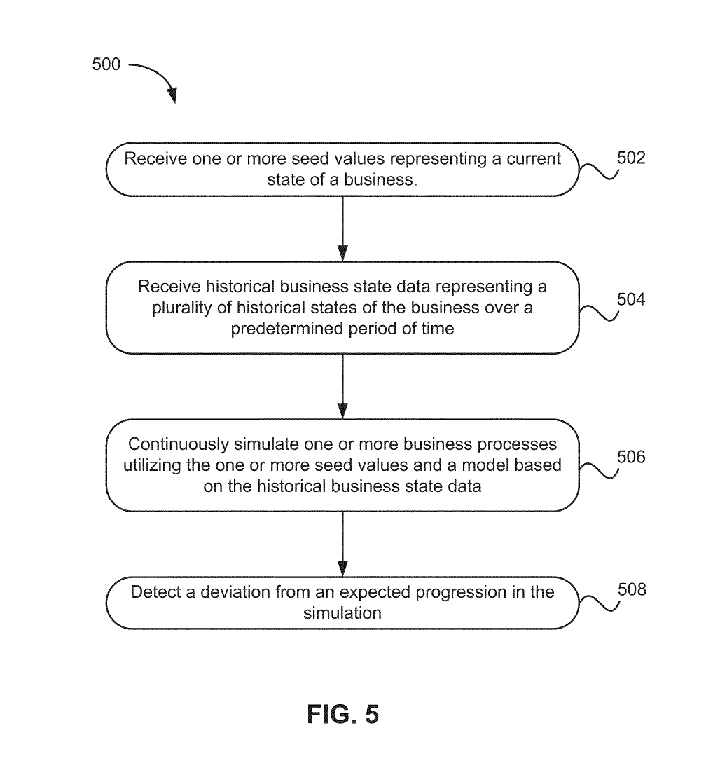

Accordingly, in one embodiment continuous simulation may be performed in accordance with a method 500, such as shown in FIG. 5. The method pray be performed in any suitable environment, including those depicted in FIGS. 1-3, among any other environment that would be understood as suitable by a person having ordinary skill in the art upon reading the present descriptions.

The method 500 includes operations 502-508. In operation 502, one or more seed values representing a current state of a business are received, e.g. at one or more resources of a distributed architecture as described herein.

In operation 504, historical business state data representing a plurality of historical states of the business over a predetermined period of time are received, again preferably at one or more distributed architecture resources.

In operation 506, using at least one processor (e.g. of the distributed architecture), one or more business processes are continuously simulated utilizing the one or more seed values and a model based on the historical business state date;

In operation 508, a deviation from an expected progression in the simulation is detected. In general, a deviation corresponds to a significant difference from historical behavior as represented in the model and/or historical business state data. The deviation may be embodied as a threshold, and represents nonstandard events (e.g. state(s)) or processes experienced by the simulated system. Such nonstandard events may create exposure to risk, liability, loss, or conversely may represent significant business opportunities, and are therefore quite useful to recognize using objective criteria such as the presently disclosed continuous simulation and deviation detection techniques.

Of course, in various embodiments the presently disclosed embodiments of continuation simulation

The method may additionally and/or alternatively include receiving user input responsive to detecting the deviation from the expected progression in the simulation; and simulating a change in the state of the business based on the one or more seed values, the model and the user input.

Preferably, the deviation is detected in response to determining a particular value representing a simulated state of the business deviates from a corresponding value representing one or more historical business state(s) of the business by an amount greater than a threshold deviation.

Particularly where the seed value(s) and deviation represent profit margin, but in any suitable embodiment, the threshold deviation is about 10%. In several approaches, at least one of the seed values and the deviation each represent a profit margin corresponding to the state of the business.

The method may additionally and/or alternatively include automatically receiving input responsive to detecting the deviation from the expected progression in the simulation; and simulating a change in the state of the business based on the one or more seed values, the model and the input. In such scenarios, the input comprises a predetermined response historically determined to be an effective response to the deviation.

In various approaches, the presently disclosed inventive concepts may be offered in the form of a service or a service platform. For example, in one embodiment the technology may take the form of a business intelligence platform referred to below as “INSIGHT®” or “Altosoft INSIGHT®.” While the descriptions below discuss an embodiment of “INSIGHT®” as definitively including one or more features or functions, e.g. by use of the terms “is” “are” “does” “will” “shall” or the like, it should be understood that the exemplary descriptions of each feature are presented by way of illustration and may be combined in any suitable combination, permutation, subset, etc. as would be understood by one having ordinary skill in the art upon reading the present descriptions.

INSIGHT® is an enterprise-class business intelligence (BI) platform that allows organizations to deploy browser-based analytics in a fraction of the time of other BI tools. From the integration of data across multiple sources to advanced transformation and analytics to drag-and-drop creation of feature-rich dashboards, INSIGHT® makes BI accessible to all on a platform that provides the scalability and performance not previously possible.

Ease of use and rapid deployment does not mean compromise. INSIGHT® takes BI to a new level with process intelligence the ability to understand data in the context of the business processes to which it is related. The result is the ability to easily measure operational effectiveness and monitor process compliance delivering clear, end-to-end visibility of process performance.

Unlike BI approaches that require multiple tools from different vendors INSIGHT® enables users to quickly access, analyze, and optimize business operations all from a single-platform. Built on INSIGHT®'s exclusive MAPAGGREGATE® distributed in-memory architecture, it can extract information from source systems in near real-time and perform high-speed calculations with unlimited scalability to ensure users have the most up-to-date and complete information regardless of the size of their data or number of users.

INSIGHT® eliminates the cost and complexity of conventional BI solutions while delivering advanced functionality for operational performance improvement and data visualization. INSIGHT® is the comprehensive platform for all BI needs.

### Process Intelligence

An organization's success is tied directly to how well it manages its business processes. To effectively manage its processes requires understanding the quality and timeliness of how they are performed. Process intelligence, the analysis of data in the context of a business process, is the next evolutionary step in advancing the power of BI.

By linking data and metrics to steps in business processes, process intelligence provides the insight necessary to understand how processes and the operations they represent are working. It can uncover bottlenecks and process exceptions that could be putting an organization's regulatory compliance at risk. It can monitor adherence to service level agreements (SLAs) or other performance obligations. Quite simply, process intelligence delivers the critical context necessary to answer questions not possible with other BI tools.

Process intelligence can also help predict future conditions that may present challenges or opportunities. INSIGHT®'s continuous simulation predictive analytics engine provides operational forecasting based on the processes being monitored. Forecasts are continually updated and refined based on the actual operational data being collected, resulting in higher accuracy. INSIGHT®'s approach overcomes the limitations of traditional statistical and static process model-based forecasting by detecting and predicting the impact of sudden changes to historical patterns and by dynamically refining the process model and operating assumptions based on the latest conditions.

### No Code Ever

An important benefit of INSIGHT®'s single-platform approach is its ability to eliminate all coding without compromising enterprise power. No SQL, no programming or scripting of any kind is ever required. This ensures that the power to access and analyze data is put in the hands of those people best prepared to understand the organization's needs. With INSIGHT®, building and deploying BI solutions is simplified to a configuration exercise using an intuitive point-and-click interface.

### Powerful and Personalized UI

INSIGHT® provides users with the ability to create powerful UIs. No more settling for rigid reports or dashboards. Easily change chart types, switch between tables and charts, manipulate the data using intuitive pivot table functionality and drill down into the details—all without needing to request changes from IT. INSIGHT® enables rich dashboard development in minutes with a browser-based, drag-and-drop interface including custom navigation and other rich interactions to optimize the data discovery process.

### MAPAGGREGATE® Multi-Server, In-Memory Design

INSIGHT®'s MAPAGGREGATE® technology is designed to address the rapidly expanding data volumes and demand for high-speed data discovery by combining the speed of in-memory processing with the scalability and flexibility of a distributed in-memory model. While first-generation in-memory BI products are limited to the memory on a single server and they require up to an additional 10% overhead for each user MAPAGGREGATE® allows INSIGHT® to overcome these limitations.

Using MAPAGGREGATE®, organizations can scale beyond the resource limits of a single-server by intelligently using the memory and CPU available on any physical or virtual server. MAPAGGREGATE® also eliminates the per-user overhead thereby allowing all available memory to be used to handle larger data volumes independent of the number of users.

### Governed Data Discovery

INSIGHT® is designed to meet the governance demands of IT organizations while supporting the empowerment of end-users promised by data discovery. It is designed to allow IT resources to centrally configure, manage and monitor shared server resources while allowing non-IT users to design and deploy dashboards and reports without requiring IT intervention.

To facilitate deployment of INSIGHT® as a governed data discovery solution the INSIGHT® platform supports a variety of deployment options. This includes the ability to configure a single deployed INSIGHT® instance, governed by IT, that can support large numbers of individual projects that can be created and operated independently by end-users.

### Deployment Flexibility

The single-platform also means a much faster implementation. INSIGHT® customers are typically operational in two to four weeks, much faster than many BI initiatives. And because business doesn't happen just at a desk, INSIGHT® provides access to dashboards on any device with a browser; data is available when and where it's needed. The platform can even alert users about critical conditions when they are offline via email or messaging.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method, comprising:
receiving data relating to a business or a business process;
processing the received data according to a metadata model, wherein the processing comprises generating metadata corresponding to each of a plurality of data portions;
partitioning received data into the plurality of data portions based at least in part on the metadata corresponding to the data portion, and
distributing each of the plurality of data portions and the metadata corresponding to each respective data portion across a plurality of resources arranged in a distributed architecture;
wherein the metadata model comprises characteristics descriptive of the data, the characteristics comprising:
semantic characteristics;
extract, transform, load (ETL) characteristics; and
usage characteristics.

2. The method as recited in claim 1, further comprising:
receiving a request relating to some or all of the data;
mapping the request to one or more of the plurality of resources in the distributed architecture based on metadata in the request;
receiving one or more responses from each of the plurality of resources in response to mapping the request;
processing e one or more responses to generate a report; and
returning the report to a resource from which the request was received.

3. The method as recited in claim 2, the request comprising metadata corresponding to the data to which the request relates.

4. The method as recited in claim 2, herein the mapping directs the request to at least one resource where a data service relating to the request resides.

5. The method as recited in claim 2, further comprising determining a location of the data prior to aggregating the one or more responses, wherein the data location is either “memory” or “archived”.

6. The method as recited in claim 5, wherein the data location “archived” is either a storage device of the distributed architecture that is not currently “in-memory” or a storage location in a database management system (DBMS) that is not currently “in-memory.”

7. The method as recited in claim 6, wherein the data location is determined to be “in-memory,” and
wherein the processing is performed directly in response to determining the data location is “in-memory”.

8. The method as recited in claim 6, further comprising:
generating one or more queries in response to determining the data location is “archived;” and
executing the queries, wherein the queries are configured to retrieve the data from the “archived” data location.

9. The method as recited in claim 8, further comprising:
loading the data e red from the data location “archived” into a memory; and
determining the data location is “in-memory” in response to the loading, and
aggregating the “in memory” data directly in response to determining the data location is “in-memory”.

10. The method as recited in claim 9, further comprising calculating one or more metrics based on the data.

11. The method as recited in claim 10, wherein the report is based at least in part on one or more of the data, the metrics, and the request.

12. The method as recited in claim 2, further comprising calculating one or more metrics based on the data, wherein the report is based at least in part on one or more of the data, the metrics, and the request.

13. The method as recited in claim 1, wherein each data portion is characterized by at least one characteristic unique from all other data portions in the received data, and
wherein each data portion is associated with at least one metadata label.

14. A method, comprising:
receiving one or more seed values representing a current state of a business;
receiving historical business state data representing a plurality of historical states of the business over a predetermined period of time;
using at least one processor, continuously simulating one or more business processes utilizing the one or more seed values and a model based on the historical business state data; and
detecting a deviation from an expected progression in the simulation.

15. The method as recited in claim 14, further comprising:
receiving user input responsive to detecting the deviation from the expected progression in the simulation; and
simulating a change in the state of the business based on the one or more seed values, the model and the user input.

16. The method as recited in claim 14, wherein the deviation is detected in response to determining a particular value representing a simulated state of the business deviates from a corresponding value representing one or more historical business state(s) of the business by an amount greater than a threshold deviation.

17. The method as recited in claim 16, wherein the threshold deviation is about 10%.

18. The method as recited in claim 14, wherein at least one of the seed values and the deviation each represent a profit margin corresponding o the state of the business.

19. The method as recited in claim 14, further comprising:
automatically receiving input responsive to detecting the deviation from the expected progression in the simulation, wherein the input comprises a predetermined response historically determined to be an effective response to the deviation; and
simulating a change in the state of the business based on the one or more seed values, the model and the input.

20. A computer program product comprises a computer readable storage medium having embodied therewith computer readable program instructions configured to cause at least one processor, upon execution, to:
receive data relating to a business or a business process;
process the received data according to a metadata model, wherein the processing comprises generating metadata corresponding to each of a plurality of data portions;
partition the received data into the plurality of data portions based at least in part on the metadata corresponding to the data portion, and
distribute each of the plurality of data portions and the metadata corresponding to each respective data portion across a plurality of resources arranged in a distributed architecture;
wherein the metadata model comprises characteristics descriptive of the data, the characteristics comprising:
semantic characteristics;
extract, transform, load (ETL) characteristics; and
usage characteristics.
